(19) United States
(12) Patent Application Publication
(10) Pub. No.: US 2003/0149579 A1
(43) Pub. Date: Aug. 7, 2003

(54) Method of increasing functionality of a product

(76) Inventors: Edwin Philip Begemann, Eindhoven (NL); Gerardus Cornelis Petrus Lokhoff, Eindhoven (NL)

Correspondence Address: PHILIPS ELECTRONICS NORTH AMERICAN CORP, 580 WHITE PLAINS RD, TARRYTOWN, NY, 10591, US

(21) Appl. No.: 10/213,404

(22) Filed: Aug. 6, 2002

(30) Foreign Application Priority Data
Aug. 10, 2001 (EP) 01203054.0

(51) Int. Cl. G06F 17/60

(52) U.S. Cl. 705/1

(57) ABSTRACT

A method of increasing functionality of a product (121) made by a manufacturer (120). A specification of an additional feature (122) is supplied to the manufacturer (120) for inclusion into a disabled state into the product (121). The technology provider (100) receives an activation payment from a third party wishing to make use of the additional feature (122).The manufacturer (120) may share this activation payment with the manufacturer (120). The product (121) can for instance be an integrated circuit, a software program and a hardware apparatus, but may also be a specification of a standard, in which case the manufacturer (120) comprises a standardization body responsible for drafting said specification.

The invention relates to a method of increasing functionality of a product.

The development of products such as integrated circuits, software programs and hardware apparatus is a costly and time-consuming process. Many different requirements need to be balanced against each other. Often it is desirable to include many different features in the product from a technical or marketing point of view, whereas the sales department wishes to keep product costs as low as possible. This typically means that optional features are not included as often as they could be to save costs.

Additional features for a product are not always developed by the manufacturer that makes the product, but also by other firms and sometimes even by private individuals. For example, a firm developing networking software may come up with a feature that would be very useful as part of a network card in a personal computer. If this firm does not make hardware network cards itself, it would be very difficult for this firm to get this feature into the market. It would have to approach hardware manufacturers and convince them to add the feature to their cards. However, since the value of this feature is not (yet) proven, but it has a definite additional cost, hardware manufacturers would not be likely to add this feature.

It is an object of the invention to provide a method according to the preamble, which provides a benefit for both the developer of the additional feature and for the manufacturer of the product in which the feature is included.

This object is achieved according to the invention in a method comprising supplying to the manufacturer a specification of an additional feature for inclusion into the product and causing the manufacturer to include the additional feature in a disabled state into the product. By providing the specification of the additional feature, which can comprise things like a complete schematic of the necessary hardware, a technical specification and/or a complete implementation in software of the additional feature to the manufacturer, it becomes very easy and less costly for the manufacturer to add the feature to the product. The additional feature is initially included in a disabled state, so that it can not be used without first switching the additional feature to an enabled state. This way, possibilities for generating additional revenue by both the manufacturer and the entity supplying the additional feature arise, as will become apparent below.

In an embodiment the method further comprises supplying an initial payment to the manufacturer in return for said including. By doing so, the manufacturer's costs for things like adapting its production process are reduced, and so he will be more likely to adopt the additional feature.

In a further embodiment the method further comprises receiving an activation payment from a third party wishing to make use of the additional feature. In return for receiving the activation payment, the additional feature is enabled in some or all of the products that were previously put on the market, so that the third party can make use of the additional feature. This way, revenue is generated for the entity that activates the additional feature.

In a further embodiment the method further comprises supplying a portion of the activation payment to the manufacturer. If the entity that developed the additional feature is the one that receives the activation payment, it can share that payment with the manufacturer. Especially when the activation payment is based on the number of product units to be activated or the number of product units on the market, the manufacturer is encouraged to include the additional feature in a large number of products.

The difference between what the developing entity receives and what the manufacturer receives serves as a source of revenue for the developing entity. This makes this embodiment particularly suitable for small entities that do not have the means to put the features they develop on the market itself, since they now can still make money off them.

In a variant of this embodiment the method further comprises supplying the portion of the activation payment to the manufacturer after the additional feature has been put in an enabled state. This serves as an incentive to the manufacturer to enable the feature only after a third party has expressed interest to the developing entity.

In a further embodiment the additional feature is protected by at least one intellectual property right, and the activation payment comprises a license fee for the at least one intellectual property right. This way, the third party obtains a license to use the feature.

In a further embodiment the additional feature is an improvement to a system made by a system developer in which the product can be used. The developing entity may be a technology provider which has come up with additional technology to overcome a limitation in an existing system. Such an additional feature would be very useful for the developer of that system.

Optionally the developing entity supplies a payment to the system developer in return for his adopting of the additional feature in the system. This may be instead of or in addition to paying the manufacturer for including the additional feature in the product. Often it is as important to get the feature adopted in a system as it is to get it included in a particular product. Paying the system developer acts as a good incentive. It is then the users who pay the activation payment to the developing entity, and of course from the activation payment the payment to the system developer and/or the manufacturer can be paid.

In a further embodiment the product comprises one of an integrated circuit, a software program and a hardware apparatus. Such products typically involve high development costs and their development would greatly benefit from including additional features in the fashion of this invention.

In a further embodiment the product comprises a specification of a standard and the manufacturer comprising a standardization body responsible for drafting said specification.

These and other aspects of the invention will be apparent from and elucidated with reference to the embodiments shown in the drawing, in which:

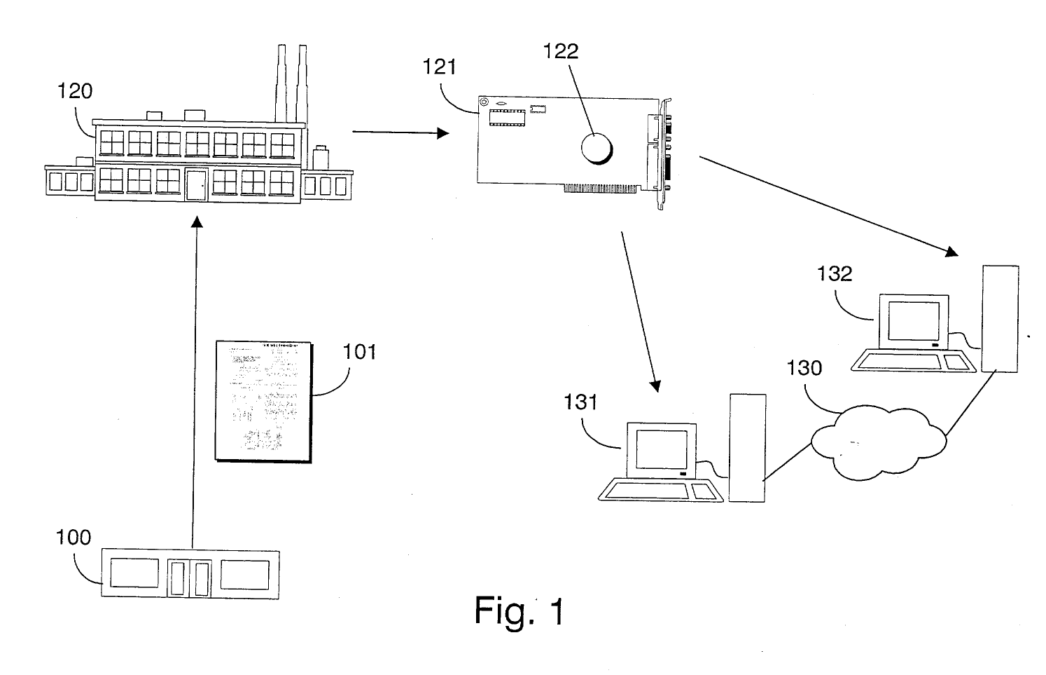

FIG. 1 schematically illustrates an embodiment of the method according to the invention; and

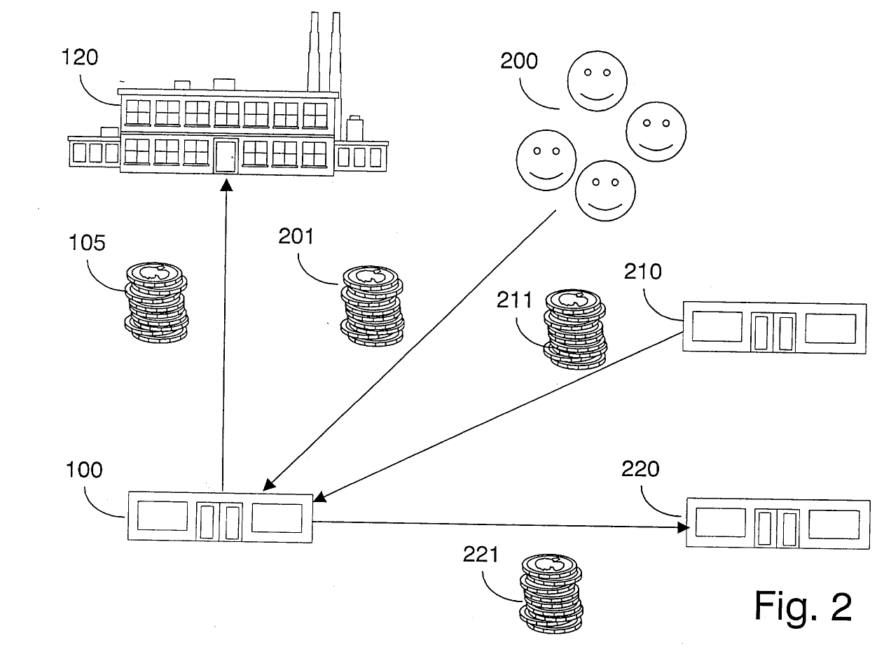

FIG. 2 schematically illustrates possible revenue streams in accordance with the invention.

Throughout the figures, same reference numerals indicate similar or corresponding features. Some of the features indicated in the drawings are typically implemented in software, and as such represent software entities, such as software modules or objects.

FIG. 1 schematically illustrates an embodiment of the method according to the invention. A technology provider 100 develops an additional feature 122 that would be a valuable addition to a product 121 that is being made by a manufacturer 120. For example, technology provider 100 could be a networking software developing company which has developed an encryption technique particularly suitable for encrypting network traffic. Such a feature would be very useful if implemented in hardware in a networking card. However, the software company does not manufacture hardware cards itself, and even if it did, the feature would still not be present in competing hardware cards, limiting the value of the feature.

The product 121 can be any type of product, for example an integrated circuit, a software program or a hardware apparatus. Similarly, the additional feature 122 can be any type of feature, as long as it is possible to provide it in the product 121 in a disabled state and to switch it to an enabled state later on. Computer peripherals, for example, typically have flash ROM memory, which can be loaded with new information. Such new information can comprise an activation code which causes the additional feature 122 to become enabled.

The product 121 can for example be embodied as a television system, a set top box, a CD or DVD player and so on, which offers an initially disabled module to play back content in a certain format as the additional feature 122. The product 121 could also be a game console, with additional features such as additional game levels, game options, objects in the game, more extensive audio and video capabilities, special effects and so on. The product 121 could also be a computer with preinstalled software packages present on the hard disk, which packages are disabled when the computer is sold.

If the product 121 is a software program, it can be a client-server software package or a component thereof. In such a case, for instance the client software package can be provided with support for the additional feature 122 in an enabled state, whereas the server software package is provided with the additional feature 122 in the disabled state. This creates an installed base of clients who can handle the additional feature 122 and so realizes a strong incentive for the operator of the server software package to make use thereof.

To secure its position, the technology provider 100 protects the additional feature 122 by at least one intellectual property right, for example by obtaining one or more patents, utility models, or design protections or through copyright protection. In this embodiment, the technology provider 100 holds a patent 101 that is technologically essential for implementing and using the additional feature 122.

The technology provider 100 now approaches the manufacturer 120 and proposes the additional feature 122 for inclusion into the product 121. Preferably the technology provider 100 does so after the manufacturer 120 has signed a non-disclosure agreement. This way, know-how and trade secrets related to the additional feature 122 are protected.

There are various ways in which the technology provider 100 could convince the manufacturer 120 to include the additional feature 122 in the product 121. By supplying the know-how necessary to implement the additional feature 122, the R&D efforts and costs on the part of the manufacturer 120 are reduced. A free license on the patent 101 may also act as an incentive.

If the manufacturer 120 is still unwilling to include the additional feature 122, the technology provider 100 may choose to supply a payment to the manufacturer 120 in return for including the additional feature 122 in the product 121. This payment can be a lump sum or be computed on a per-unit basis, and may be paid up front or during the development process. For instance, the technology provider 100 may offer to pay the development costs incurred by the manufacturer 120 for including the additional feature 122 in the product 121.

The technology provider 100 may, in addition to or instead of the payment mentioned above, also offer to share its expected revenue from activation payments with the manufacturer 120. Activation payments are explained below.

Having been convinced by the technology provider 100, the manufacturer 120 now sets out to manufacture the product 121 including the additional feature 122 and causes it to be put to the market. The additional feature 122 must be included in a disabled state into the product 121. That is, when the product 121 is bought, the additional feature 122 is not available for use without first activating it in some way.

Various ways exist to activate a disabled feature in a product. For example, an activation code may be entered that causes a processor to enable the disabled feature. This activation code should ideally be unique for each product unit, to make it possible that the additional feature 122 is only enabled in a select number of units.

In particular, in the field of software development it is long known to provide so-called shareware programs, in which part of the functionality is disabled in the demonstration version. The user can then try out the program before he buys it, but can for instance not print documents or only operate the program for sixty minutes in a row. If the product 121 is a software program, any of these techniques can be used to switch the additional feature 122 to an enabled state.

Users, which can be private individuals or professional users like companies, buy the product 121 and install it if necessary. For example, a network administrator may buy networking cards and install them in the computers 131, 132 connected to a network 130. Initially, the additional feature 122 is not available, so the network administrator notices no difference with cards not having the additional feature 122. Preferably the cost for adding the additional feature 122 to the product 121 are borne by the technology provider 100, so that the retail price for the product 121 will not have increased.

However, at some point he learns about the additional feature 122, for example through a brochure by the technology provider 100 or the manufacturer 120, or by studying the manual that comes with the product 121. If it turns out that the additional feature 122 is useful for him, he will approach the technology provider 100 to have the additional feature 122 enabled. The technology provider 100 charges a fee, the activation payment, for providing the necessary means for enabling the additional feature 122. Having paid the activation payment, the additional feature 122 is enabled on the products 121 installed in computers 131, 132 and the network administrator benefits from their increased functionality.

FIG. 2 schematically illustrates possible revenue streams in accordance with the invention. As stated above, the technology provider 100 receives activation payments 201, 211 from third parties such as private individuals 200 and corporations 210 in return for supplying to these third parties 200, 210 the necessary means to activate the additional feature 122.

The technology provider 100 supplies a payment 105 to the manufacturer 120. This payment 105 can comprise an initial payment to the manufacturer 120 in return for including the additional feature 122 in the product 121. The payment 105 may also be intended to cover development and manufacturing costs in whole or in part.

The payment 105 may comprise a portion of the activation payment. This way, the manufacturer 120 receives an additional incentive to include the additional feature 122 in the product 121. When the activation payment is based on the number of product units to be activated or the number of product units on the market, the manufacturer 120 is encouraged to include the additional feature in a large number of products.

The difference between what the technology provider 100 receives and what the manufacturer 120 receives serves as a source of revenue for the technology provider 100. This makes this embodiment particularly suitable for small entities that do not have the means to put the features they develop on the market itself, since they now can still make money off them.

The activation payment may comprise a license fee for any intellectual property rights (IPR) that protect the additional feature 122. However, this depends on the IPR which the technology provider 100 holds, the contract between technology provider 100 and manufacturer 120 and on local regulations with respect to exhaustion of rights caused by the sale of the product 120 including the additional feature 122 in an initially disabled state.

If the additional feature is an improvement to a system made by a system developer 220 in which the product can be used, then it may be advantageous for the technology provider 100 to supply a payment 221 to the system developer 220 in return for his adopting of the additional feature 122 in the system. This may be instead of or in addition to paying the manufacturer for including the additional feature in the product.

Often it is as important to get the feature adopted in a system as it is to get it included in a particular product. Paying the system developer acts as a good incentive. It is then the users who pay the activation payment to the developing entity, and of course from the activation payment the payment to the system developer and/or the manufacturer can be paid.

Optionally, a usage fee can be charged to users, which provides a recurring revenue stream. This stream may or may not be shared with the manufacturer 120 or the system developer 220.

The product 121 may alternatively comprise a specification of a standard. In that case, the manufacturer 120 comprises a standardization body responsible for drafting said specification. The additional feature 122 that is to be included with the product 121 then is an optional part of the specification, which is enabled by having the standardization body making the optional part mandatory in a future version of the specification.

Alternatively, the activation payments 201, 211 from private individuals 200 and corporations 210 may be received by the manufacturer 120 and then passed on to the technology provider 100, preferably after subtracting a handling fee and/or the payment 105. This way, the manufacturer 120 leverages his existing business relationship with the customers of the product 121 to handle the reception of the activation payments 201, 211. Further, the individuals 200 and corporations 210 now only have to make payments to one entity.

It should be noted that the above-mentioned embodiments illustrate rather than limit the invention, and that those skilled in the art will be able to design many alternative embodiments without departing from the scope of the appended claims. In the claims, any reference signs placed between parentheses shall not be construed as limiting the claim. The word “comprising” does not exclude the presence of elements or steps other than those listed in a claim. The word “a” or “an” preceding an element does not exclude the presence of a plurality of such elements. The invention can be implemented by means of hardware comprising several distinct elements, and be means of a suitably programmed computer. The mere fact that certain measures are recited in mutually different dependent claims does not indicate that a combination of these measure cannot be used to advantage.

1. A method of increasing functionality of a product made by a manufacturer, comprising supplying to the manufacturer a specification of an additional feature for inclusion into the product and causing the manufacturer to include the additional feature in a disabled state into the product.

2. The method of claim 1, further comprising supplying an initial payment to the manufacturer in return for said including.

3. The method of claim 1, further comprising receiving an activation payment from a third party wishing to make use of the additional feature.

4. The method of claim 3, further comprising supplying a portion of the activation payment to the manufacturer.

5. The method of claim 4, further comprising supplying the portion of the activation payment to the manufacturer after the additional feature has been put in an enabled state.

6. The method of claim 3, whereby the additional feature is protected by at least one intellectual property right, and the activation payment comprises a license fee for the at least one intellectual property right.

7. The method of claim 1, whereby the additional feature is an improvement to a system made by a system developer in which the product can be used.

8. The method of claim 7, further comprising supplying a payment to the system developer in return for his adopting of the additional feature in the system.

9. The method of claim 1, the product comprising one of an integrated circuit, a software program and a hardware apparatus.

10. The method of claim 1, the product comprising a specification of a standard and the manufacturer comprising a standardization body responsible for drafting said specification.
